(19) United States
(12) Patent Application Publication
(10) Pub. No.: US 2025/0292564 A1
(43) Pub. Date: Sep. 18, 2025

(54) INFORMATION PROCESSING APPARATUS AND CONTROL METHOD THEREFOR

(71) Applicant: CANON KABUSHIKI KAISHA, Tokyo (JP)

(72) Inventor: Yujiro SOEDA, Kanagawa (JP)

(21) Appl. No.: 19/073,134

(22) Filed: Mar. 7, 2025

(30) Foreign Application Priority Data
Mar. 13, 2024 (JP) 2024-038768

(51) Int. Cl. G06V 10/96; G06V 10/74; G06V 10/776; G06V 10/82

(52) U.S. Cl. CPC G06V 10/96; G06V 10/761; G06V 10/776; G06V 10/82

(57) ABSTRACT

An information processing apparatus for managing a plurality of learning models published on a model public platform, comprises: a management unit that manages, for each of the plurality of learning models, first information concerning a learning history of the learning model, and second information concerning a base model used to create the learning model; and a determination unit that determines a publication range of each of the plurality of learning models on the model public platform based on both the first information and the second information.

### BACKGROUND OF THE INVENTION

### Field of the Invention

The present invention relates to a technique for managing learning models and learning data.

### Description of the Related Art

In recent years, Artificial Intelligence (AI) technologies using machine learning have developed remarkably, and have been applied to various products and services including image recognition and automatic translation. Most recently, AI, called generative AI, that generates content such as a sentence or an image based on a user input has appeared and received a great deal of attention.

Many of the AI technologies are implemented by learning models (learned models) created by companies, research institutes, and the like. However, it is expected to become common for a general user to execute machine learning in accordance with a user's application and create a learning model. Along with this, it is expected that execution of machine learning, publication of a learning model, and the like by a general user will become popular via a service through the Internet. Such service will be referred to as a “learning model public platform” hereinafter.

On the learning model public platform, it is possible to download and use a learning model published by another user. At this time, it is estimated that model creation by the user on the platform is activated by paying part of the download fee to the model creator as a compensation. In model creation, it is estimated that the user performs incremental learning in accordance with his/her application using, as an initial model, a learning model published by another user, and publishes a thus obtained learning model. Note that the published learning model and data used for learning need to comply with ethics and shall not infringe on copyright and portrait rights.

Japanese Patent Laid-Open No. 2023-64636 (patent literature 1) discloses a technique capable of creating a learning model in compliance with AI ethics by performing AI ethics assessment based on a learning condition at the start of machine learning and executing learning only when it is determined that AI ethics are complied with.

However, the AI ethics code which the learning model should satisfy may be revised. In the technique described in patent literature 1, even if the learning model complies with the code at the time of learning the learning model, it is not guaranteed that the learning model created after the revision of the code complies with the AI ethics after the revision of the code.

Therefore, a problem may arise even after the learning model created in accordance with the technique described in patent literature 1 is published on the learning model public platform. That is, in addition to the published learning model, a derived model created by performing incremental learning using the learning model as the initial model may not also satisfy the AI ethics after the revision of the code. In addition, on the learning model public platform, a derived model obtained by insufficient incremental learning (a derived model that is not substantially different from the initial model) may be published. Thus, not only publication of a learning model but also publication of a derived model needs to be managed and controlled.

### SUMMARY OF THE INVENTION

According to one aspect of the present invention, an information processing apparatus for managing a plurality of learning models published on a model public platform, comprises: a management unit that manages, for each of the plurality of learning models, first information concerning a learning history of the learning model, and second information concerning a base model used to create the learning model; and a determination unit that determines a publication range of each of the plurality of learning models on the model public platform based on both the first information and the second information.

The present invention appropriately controls publication of a learning model.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the functional configuration of an information processing apparatus.

FIG. 2 shows tables each showing an example of information added to a model.

FIG. 3 is a view showing an example of learning data.

FIG. 4 shows tables each showing an example of information added to data.

FIG. 5 is a view showing an example of traceability information.

FIG. 6 is a table showing an example of publication standard information.

FIGS. 7A and 7B are flowcharts of processing in the information processing apparatus (first embodiment).

FIG. 8 is a flowchart of processing in an information processing apparatus (second embodiment).

FIGS. 9A and 9B are flowcharts of processing in an information processing apparatus (third embodiment).

FIG. 10 is a flowchart of processing in the information processing apparatus (modification).

FIG. 11 is a view showing an example of a traceability information management screen.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

As the first embodiment of an information processing apparatus according to the present invention, an information processing apparatus that controls the publication range of a learning model will be exemplified below. Especially, an example in which if learning data includes an ethically or legally (in terms of copyright and portrait rights) problematic image, the publication range of the learning model is narrowed (limited publication) or publication is prohibited (private).

### Overview

The information processing apparatus according to this embodiment manages information (a learning data ID) concerning data used to learn a learning model (learned model) in association with the learning model. In addition, in a case where the learning model is a derived model, the information processing apparatus manages, in association with the learning model, information (an initial model ID) concerning a base model (initial model) used. Then, the information processing apparatus manages traceability information (the past history of a learning model) based on the initial model ID and the learning data ID of each of the plurality of learning models, and controls the publication range of each learning model based on the traceability information.

### Terms

An “ethically problematic image” indicates, for example, an image that implies violence or discrimination or an image with sexual content. A “problematic image in terms of copyright and portrait rights” is an image that infringes on copyright and portrait rights. The image is, for example, an image for which a right holder does not allow broad public use for image duplication, machine learning, or the like. Examples of this image are photos of celebrities published by entertainment agencies, and character images for animations. In the following description, an “ethically problematic image” and a “problematic image in terms of copyright and portrait rights” will sometimes collectively be referred to as “NG images” hereinafter.

### <Apparatus Configuration>

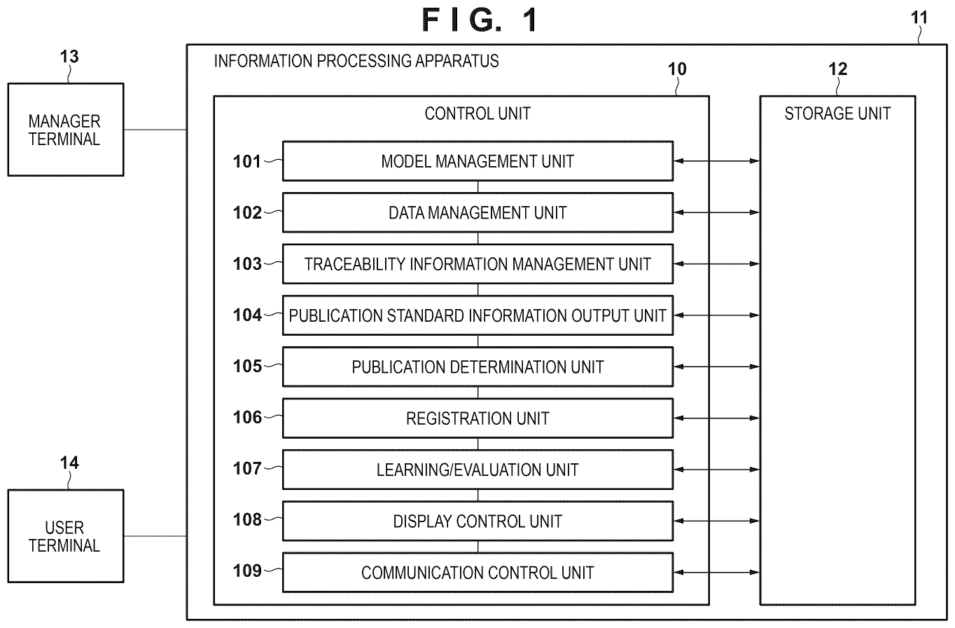

FIG. 1 is a block diagram showing the function configuration of an information processing apparatus 11. The information processing apparatus 11 manages a “model” and “data” used to learn and evaluate the model. Furthermore, the information processing apparatus 11 learns a model or edits data in response to a request from a user (the user of the learning model public platform), and edits model information in response to a request from a manager (the manager of the learning model public platform) (publication determination).

The information processing apparatus 11 is connected in a communication-enabling manner to a manager terminal 13 and a user terminal 14 via a communication network such as a local area network (LAN) or the Internet. The connection method is not particularly limited. For example, each terminal may be connected via a wire or connected via wireless communication. FIG. 1 shows one manager terminal and one user terminal but the present invention is not limited to this. Assume that each of the manager terminal 13 and the user terminal 14 is an information terminal such as a personal computer (PC), a mobile phone, or a tablet terminal apparatus.

The information processing apparatus 11 includes a control unit 10 and a storage unit 12. The control unit 10 can be implemented when, for example, a central processing unit (CPU) executes various kinds of programs stored in the storage unit 12. The storage unit 12 is a random access memory (RAM), a read only memory (ROM), or a mass storage device such as a hard disk drive (HDD) or a solid-state drive (SSD).

The control unit 10 includes a model management unit 101, a data management unit 102, a traceability information management unit 103, a publication standard information output unit 104, a publication determination unit 105, a registration unit 106, a learning/evaluation unit 107, a display control unit 108, and a communication control unit 109. As described above, these functional units can be implemented when, for example, the CPU executes various kinds of programs. However, some or all of the functional units may be implemented by hardware such as an Application Specific Integrated Circuit (ASIC).

The model management unit 101 manages models registered in the information processing apparatus 11. This embodiment assumes that the model is an “object detection model” that aims at performing object detection from an image, but the present invention is not limited to this. The model may be a speech recognition model, a natural language processing model, or a generative artificial intelligence (AI) model.

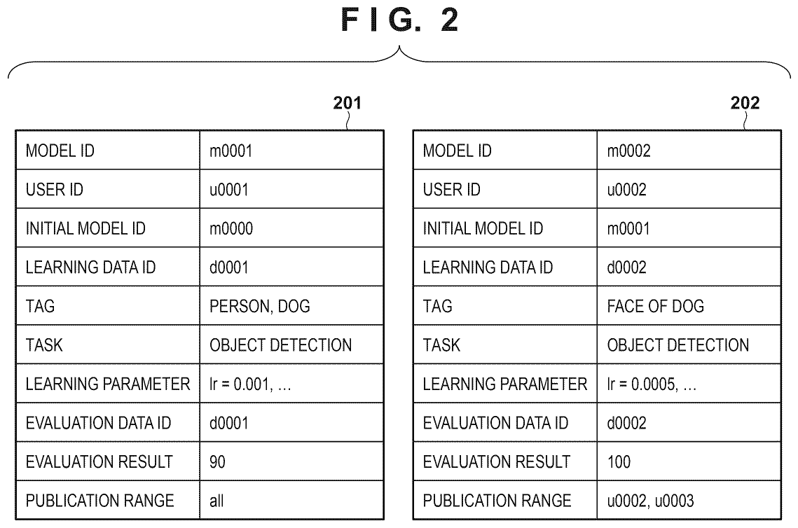

FIG. 2 shows tables of examples of model information 201 and model information 202 added to two models, respectively. The model information is attribute information of the model, and includes pieces of information of a model ID, a user ID, an initial model ID, a learning data ID, a tag, a task, a learning parameter, an evaluation data ID, an evaluation result, and a publication range. That is, the model information includes the learning data ID and the learning parameter as a learning history.

The model ID is model-specific identification information (ID) for identifying each model. The user ID is a user-specific ID for identifying a user who has performed learning for each model. The initial model ID is a model ID for designating a model that serves as an initial parameter when learning each model.

Referring to FIG. 2, in the model information 201, the model ID is “m0001” and the initial model ID is “m0000”. In the model information 202, the model ID is “m0002” and the initial model ID is “m0001”. Therefore, it is indicated that the model with the model ID “m0002” is a model obtained as a result of performing learning by using the model with the model ID “m0001” as the initial model.

The learning data ID is a learning data-specific ID for identifying a data set used to learn each model. In the tag, information of an object targeted by each model, information necessary for the user to search for a model, or the like is described. In the task, a type of processing (object detection, image generation, or the like) targeted by each model is described. The learning parameter is a hyperparameter (a learning rate, a learning count, or the like) used to learn each model. The evaluation data ID is a data ID for designating a data set used to evaluate each model. In the evaluation result, a numerical value obtained as a result of evaluation or the like is described. In the publication range, information representing the publication range (a range within which publishing is permitted) of each model is described. For example, all (published to all (public)), private, or one or more user IDs are described. If a user ID is described, only a user having the described ID can access the model, and other users cannot access the model.

As shown in FIG. 2, the model information 201 or 202 is model information of a model for an object detection model. For example, if the model is a model of another type (a speech recognition model or the like), items included in the model information may be different from those in the example shown in FIG. 2.

The data management unit 102 manages data registered in the information processing apparatus 11. The data according to this embodiment is image data for object detection.

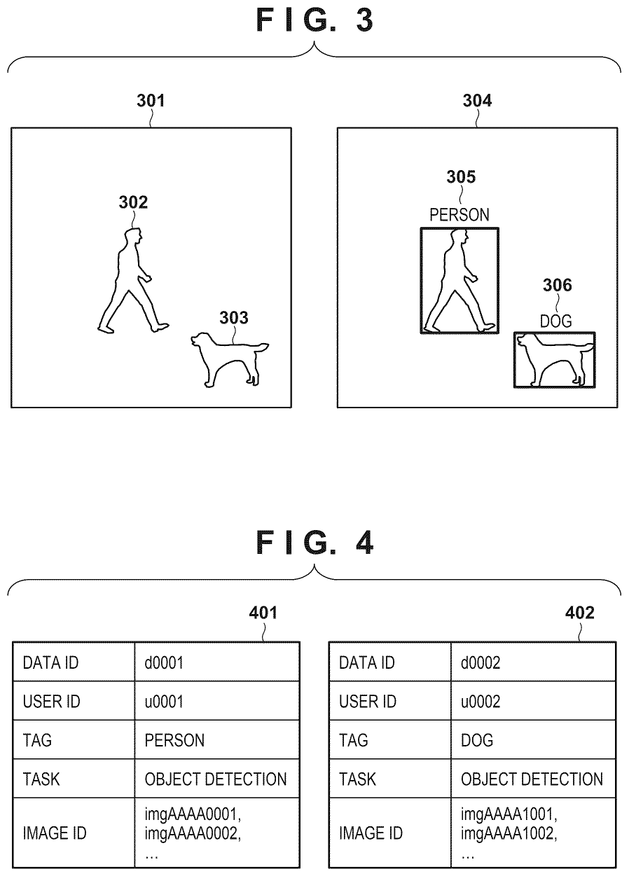

FIG. 3 is a view showing an example of learning data. The learning data includes an image 301 and a ground truth 304. The image 301 is an image including an object (in this example, a person 302 and a dog 303) which the user wants to recognize. To learn object detection, not only an image but also object information as a ground truth is necessary. The object information is, for example, bounding box (BB) information corresponding to information of the position and size of an object in the image. A BB 305 is a BB corresponding to the person 302 and a BB 306 is a BB corresponding to the dog 303.

FIG. 4 shows tables showing examples of data information 401 and data information 402 added to data (image data sets), respectively. The data information is attribute information of data and includes pieces of information of a data ID, a user ID, a tag, a task, and an image ID.

The data ID is a data-specific ID for identifying each data. The user ID is a user-specific ID for identifying a user who has created each data. In the tag, information of an object targeted by each data, information necessary for the user to search for data, or the like is described. In the task, a type of processing (object detection, image generation, or the like) targeted by each data is described. The image ID is an image-specific ID for identifying one or more images included in the data. Each data includes one or more image IDs.

As shown in FIG. 4, the data information 401 or 402 is data information of data used for a model for an object detection model. For example, if the data is data used for a model of another type (a speech recognition model or the like), items included in the data information may be different from those in the example shown in FIG. 4.

The data management unit 102 receives registration of data from the user, and newly registers a data set.

The traceability information management unit 103 manages traceability information of models. The traceability information is information representing how the models were created in the past (that is, the past history of the models), and is, for example, information generated based on the model information.

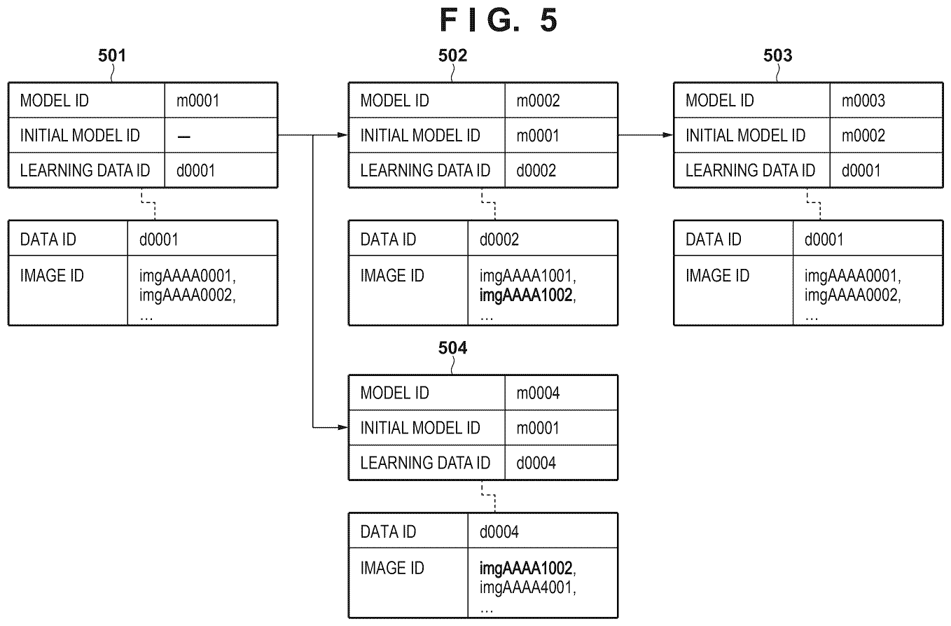

FIG. 5 is a view showing an example of the traceability information. Referring to FIG. 5, an arrow represents the derivative relationship between models. For example, it is indicated that a model 502 (the model ID is “m0002”) is a derived model created by performing incremental learning by using a model 501 (the model ID is “m0001”) as the initial model. Similarly, it is indicated that a model 503 is a derived model of the model 502 and a model 504 is a derived model of the model 501. Note that in FIG. 5, the initial model ID indicated in the model 501 is “-”, which indicates that the initial model is an unlearned model.

As described above, since the traceability information indicates records obtained by editing the models in the past, it is possible to identify one or more models used to create each model by tracing the traceability information. For example, based on the traceability information shown in FIG. 5, it can be said that all the models 502 to 504 are derived models of the model 501. Furthermore, it is possible to identify data used to learn each model based on the learning data ID of each model shown in FIG. 5, and the linked relationship between the model and the data can be indicated by a dotted line in FIG. 5.

The publication standard information output unit 104 outputs publication standard information to be used as one determination criterion of model publication determination. Although details will be described later, the publication standard information is information output, for each model, based on the model information obtained from the model management unit 101 and the data information obtained from the data management unit 102.

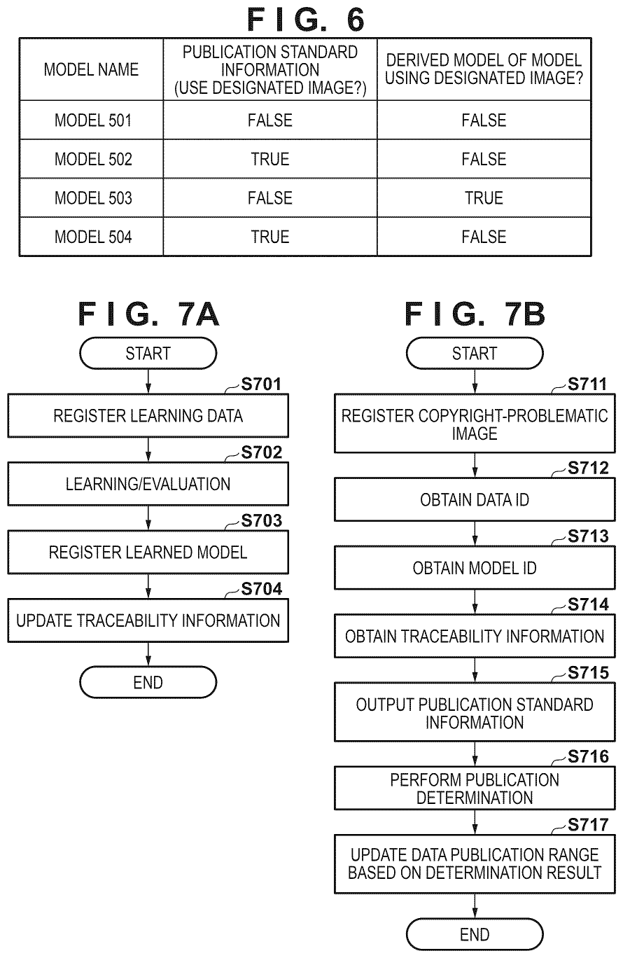

FIG. 6 is a table showing an example of the publication standard information. For example, the publication standard information is information representing whether each model uses a specific image (an image with an image ID designated from the manager terminal 13) as learning data. For example, assume that an image with an image ID (“imgAAAA1002”) shown in bold in FIG. 5 is an “NG image” and the manager designates the image as an unavailable image via the manager terminal 13. Referring to FIG. 5, the data IDs of the data each including the image are “d0002” and “d0004”, and models that use these data are the models 502 and 504. Thus, the publication standard information is “FALSE” for the models 501 and 503 and “TRUE” for the models 502 and 504, as shown in FIG. 6 (the center column).

The publication determination unit 105 performs model publication determination based on the publication standard information (first determination result) output from the publication standard information output unit 104 and a determination result (second determination result) based on the traceability information managed by the traceability information management unit 103. Note that as shown in FIG. 6 (the right column), the determination result based on the traceability information is a result of whether each model is a derived model of a model leaned by using the “NG image”. For example, referring to FIG. 5, since the model 503 is a derived model of the model 502, the determination result is “TRUE”.

Then, the publication determination unit 105 performs model publication determination based on the publication standard information and the determination result based on the traceability information. In this example, the publication determination unit 105 determines “private” for the model 502 or 504 whose publication standard information is “TRUE”, and determines “limited publication (publication to one or more specific user IDs)” for the model 503 whose publication standard information is “FALSE” but whose traceability information is “TRUE”. Note that “public” is determined for the remaining models.

Based on the determination result (public, private, or limited publication) of the publication determination unit 105, the registration unit 106 updates the value of the publication range in the model information of each model registered in the information processing apparatus 11.

The learning/evaluation unit 107 learns or evaluates the model based on the model and data registered in the information processing apparatus 11.

The display control unit 108 executes control to display the results of the information processing apparatus 11 for the requests from the manager terminal 13 and the user terminal 14. For example, screen generation of a management screen (to be described in the fourth embodiment) displayed on the manager terminal 13 is also performed. The communication control unit 109 controls transmission/reception of information to/from the manager terminal 13 or the user terminal.

The storage unit 12 stores the above-described various kinds of programs executed by the CPU, and also stores models, model information, data, data information, traceability information, and the like.

### <Operation of Apparatus>

FIGS. 7A and 7B are flowcharts of processing in the information processing apparatus 11. FIG. 7A is a flowchart when learning and registering a model. FIG. 7B is a flowchart when determining/updating the publication range of the model.

First, processing when the user operates the user terminal 14 to register data in the information processing apparatus 11 and learn a model will be described with reference to FIG. 7A. A status in which new data (data set) is registered and incremental learning is performed for one of already registered models using the data will now be described.

In step S701, upon receiving a data addition request from the user terminal 14, the registration unit 106 registers data in the storage unit 12. The registered data is added with data information as indicated by the data information 401. When registering data, the publication range of the data and pieces of information of a tag and a task can be added. Assume here that the data ID of the data registered by the user is “d0001”.

In step S702, upon receiving a learning execution request from the user terminal 14, the learning/evaluation unit 107 executes learning using the data registered by the user. For example, the learning/evaluation unit 107 receives designation of the model (the model ID is “m0000”) from the user, and executes learning for the model by using the data (the data ID is “d0001”). Note that the model with the model ID “m0000” is an unlearned model, and is registered in advance in the storage unit 12.

As a learning method of object detection, there is provided, for example, a method using a neural network (NN). Literature A describes details of the learning method of object detection using the NN. The learning/evaluation unit 107 may evaluate the data used for learning or the model learned using arbitrary data.
(Literature A) Tian et al., “FCOS: Fully Convolutional One-Stage Object Detection”, arXiv: 1904.01355, 2019

In step S703, the registration unit 106 registers the model learned by the user in the storage unit 12. When registering the model, for example, model information as indicated by the model information 201 is added. Note that the user ID is the ID of the user who is operating the user terminal 14.

In step S704, the traceability information management unit 103 updates the traceability information. That is, as shown in FIG. 5, the model 501 (the model ID is “m0001”) is managed in linkage with the data (the data ID is “d0001”).

As described above, the data (the data ID is “d0001”) prepared by the user and the model 501 (the model ID is “m0001”) learned using the data are registered in the information processing apparatus 11.

Next, processing when determining/updating the publication range of the model will be described with reference to FIG. 7B. A status in which the manager newly designates (registers) an NG image will now be described.

In step S711, upon receiving a registration request of an NG image from the manager terminal 13, the registration unit 106 registers the NG image. For example, the registration unit 106 may directly receive the image ID of the NG image, or may display a plurality of images on the display unit (not shown) of the manager terminal 13 and receive selection of the NG image from the manager. In this example, “imgAAAA1002” shown in FIG. 5 is received as the image ID of the NG image and the NG image is registered.

In step S712, the data management unit 102 obtains the data ID of data including the image ID of the NG image. In the status shown in FIG. 5, “d0002” and “d0004” are obtained.

In step S713, the model management unit 101 obtains a model ID having, as the learning data ID, the data ID obtained in step S712. In the status shown in FIG. 5, “m0002” and “m0004” are obtained.

In step S714, the traceability information management unit 103 obtains traceability information. In this example, the traceability information shown in FIG. 5 is obtained.

In step S715, the publication standard information output unit 104 outputs publication standard information for each of the model IDs obtained in step S713. In this example, “TRUE” is output for the models 502 and 504 corresponding to the model IDs obtained in step S713, and “FALSE” is output for the remaining models (FIG. 6 (the center column)).

In step S716, the publication determination unit 105 performs publication determination of each model stored in the storage unit 12 based on the publication standard information output in step S715 and the traceability information obtained in step S714. First, it is determined based on the traceability information obtained in step S714 whether each model is a derived model of the model learned using the “NG image” (derived model information). In this example, “TRUE” is output for the model 503 as a learning model of interest to which attention is currently paid, and “FALSE” is output for the remaining models (FIG. 6 (the right column)). Then, publication determination is performed based on both the two pieces of information (publication standard information and derived model information) of each model.

In step S717, the registration unit 106 updates the value of the publication range in the model information of each model based on the result of the publication determination in step S716.

As described above, according to the first embodiment, it is possible to effectively determine the publication range of a model that has used the NG image for learning and a derived model of the model.

### (Modification 1-1)

The above-described publication determination unit 105 determines limited publication for a model whose publication standard information is “FALSE” and whose derived model information is “TRUE”. However, before determining limited publication, model performance verification of the model may be performed, thereby obtaining a final publication determination result.

The model performance verification is verification of whether each model has the performance designated by the manager. For example, if the model is a personal authentication model, verification of whether the model has the performance of identifying a person (for example, a person included in the above-described NG image) included in an image designated by the manager terminal 13 is performed.

Then, the publication determination unit 105 determines “private” for the model whose result of the model performance verification is “TRUE” (=the model has the performance of identifying the person), and determines “public” or “limited publication” for the model whose result of the model performance verification is “FALSE”.

### Second Embodiment

In the second embodiment, another information processing apparatus that controls the publication range of a learning model will be exemplified below. In particular, an example of determining “limited publication” or “private” based on a generated image obtained by the execution result of the model will be described.

### <Apparatus Configuration>

The functional configuration of the information processing apparatus according to the second embodiment is the same as in the first embodiment (FIG. 1) and a detailed description thereof will be omitted. Functional units whose operations are different from the first embodiment will mainly be described below. In the following description, assume that the model is an “image generation model” that generates an illustration or photo based on input text information, but the present invention is not limited to this.

Publication standard information output from a publication standard information output unit 104 according to the second embodiment is the similarity between a generated image and a ground truth image for a predetermined keyword (for example, a character name of an animation unavailable in terms of copyright). The generated image is an image generated when the model executes the keyword input from a manager terminal 13. Note that a character string (a logo, a copyright notice, or the like) of a watermark image embedded in an image may be used as a keyword.

A publication determination unit 105 performs publication determination for a model registered in a storage unit 12 based on the publication standard information output from the publication standard information output unit 104 and traceability information managed by a traceability information management unit 103.

As described above, the publication standard information is the similarity between the ground truth image and the generated image. Thus, the ground truth image indicated by the keyword input from the manager terminal 13 is prepared and registered in advance. For example, if the input keyword is “character A”, the ground truth image of character A is prepared and registered in advance.

Then, a similarity calculation unit included in the publication determination unit 105 calculates the similarity between the ground truth image and the generated image. If the similarity exceeds a predetermined threshold, similarity determination indicates “TRUE”. If similarity determination indicates “TRUE”, this indicates that an image unavailable in terms of copyright is highly probably used for learning data (although the image is not the same as the registered NG image). To cope with this, the publication determination unit 105 determines “private” or “limited publication” for the model whose similarity determination indicates “TRUE” and a derived model of the model. Note that “public” is determined for the remaining models.

Note that the similarity between the ground truth image of the input keyword and the generated image is used as a determination condition, but the present invention is not limited to this. A classifier may be provided in the publication determination unit 105, and whether a classification result of processing the generated image by the classifier matches the keyword may be used as a determination condition.

### <Operation of Apparatus>

In processing of the information processing apparatus according to the second embodiment, processing of learning and registering a model is the same as in the first embodiment (FIG. 7A) and a description thereof will be omitted.

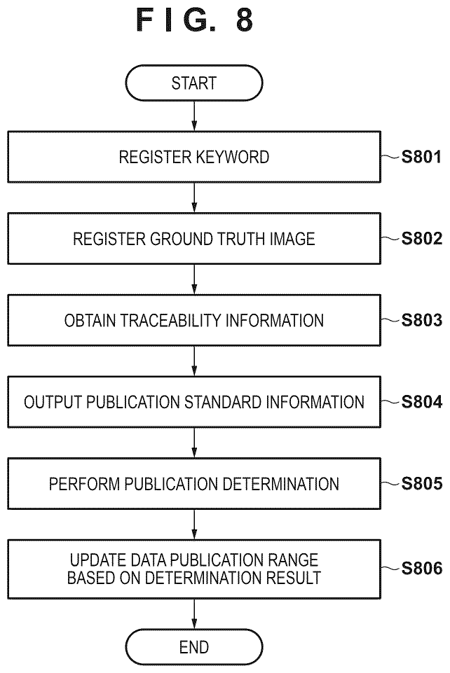

FIG. 8 is a flowchart when determining/updating the publication range of a model according to the second embodiment.

In step S801, upon receiving a registration request of a keyword from the manager terminal 13, the publication standard information output unit 104 registers the keyword.

In step S802, upon receiving a registration request of a ground truth image corresponding to the keyword registered in step S801 from the manager terminal 13, the publication determination unit 105 registers the ground truth image in association with the keyword.

In step S803, the traceability information management unit 103 obtains traceability information. In this example, traceability information shown in FIG. 5 is obtained. Note that in the second embodiment, it may be configured to obtain the traceability information only about derivative information (an arrow in FIG. 5) between models.

In step S804, the publication standard information output unit 104 inputs the keyword registered in step S801 to a public model stored in the storage unit 12, thereby generating an image. Then, the similarity between the ground truth image corresponding to the keyword and the generated image is output as publication standard information.

In step S805, the publication determination unit 105 performs publication determination of each model stored in the storage unit 12 based on the publication standard information output in step S804 and the traceability information obtained in step S803. A detailed operation of publication determination in the publication determination unit 105 is as described above.

In step S806, a registration unit 106 updates the value of the publication range in the model information of each model based on the result of the publication determination in step S805.

As described above, according to the second embodiment, the similarity between a generated image obtained by inputting a keyword associated with an NG image to a model and a ground truth image corresponding to the keyword is calculated, and the publication range of the model and a derived model thereof is determined based on the similarity. In particular, if the similarity exceeds the predetermined threshold, it is determined that the image similar to the NG image is highly probably used to learn the model, and “private” or “limited publication” is determined for the model and the derived model thereof. Therefore, it is possible to effectively determine the publication range of the model that has used not only the registered NG image but also the image similar to the NG image and a derived model of the model.

### Third Embodiment

In the third embodiment, another information processing apparatus that controls the publication range of a learning model will be exemplified below.

### Overview

As a problem for model publication on the learning model public platform, a derived model having substantially the same performance as that of a highly evaluated model is registered on the platform. In this case, a compensation that should be paid to a user who has created the highly evaluated model is paid to the third party who has registered the derived model. Thus, there is a need to secure the sense of fairness/satisfaction of the user who has created the highly evaluated model.

To cope with this, when a derived model (to be also referred to as a child model hereinafter) is newly registered in the information processing apparatus of this embodiment, the information processing apparatus confirms the similarity between the derived model and an initial model (to be also referred to as a parent model hereinafter). Then, if the similarity between the derived model and the initial model is higher than a predetermined threshold (the derived model is substantially identical to the initial model), the information processing apparatus determines “limited publication” or “private” for the derived model.

### <Apparatus Configuration>

The functional configuration of the information processing apparatus according to the third embodiment is the same as in the first embodiment (FIG. 1) and a detailed description thereof will be omitted. Functional units whose operations are different from the first embodiment will mainly be described below. In the following description, assume that the model is an “object detection model”, similar to the first embodiment, but the present invention is not limited to this.

Based on traceability information managed by a traceability information management unit 103, a model management unit 101 according to the third embodiment obtains, from a storage unit 12, model information of each of a model (child model) registered by the user using a user terminal 14 and a parent model thereof. The obtained model information is transferred to a publication standard information output unit 104.

The publication standard information output unit 104 obtains a learning history (a learning data ID and a learning parameter) from the model information of each of the parent model and the child model. Then, it is determined whether the learning data and the learning parameter are the same between the models, and “determination result” and “learning count of child model” are output as publication standard information.

With respect to the identity of the learning data between the models, the models determine the identity/similarity between the learning data used for learning. For example, the identity may be determined by determining whether the learning data IDs are the same. Alternatively, the identity/similarity of a plurality of image IDs included in the learning data of the models may be determined. For example, if a plurality of image IDs included in the learning data of the child model and a plurality of image IDs included in the learning data of the parent model overlap by a predetermined percentage or more (for example, 99% or more) (the difference is smaller than a predetermined percentage), the data of the models may be regarded to be substantially identical.

The identity of the learning parameters between the models is determined by comparing the learning parameters except for the learning counts. For example, if only the learning parameter (the storage destination of log data of the learning process or the like) that does not influence the model performance is different, the learning parameters may be regarded to be identical.

A publication determination unit 105 performs publication determination for the child model based on the publication standard information output from the publication standard information output unit 104. For example, if the determination results of the identity of the learning data and the identity of the learning parameters between the parent model and the child model are “TRUE” and the learning count of the child model is smaller than the predetermined number, “private” is determined for the child model. That is, in this case, the child model has hardly progressed in learning from the parent model, and the models can be regarded to be substantially identical.

### <Operation of Apparatus>

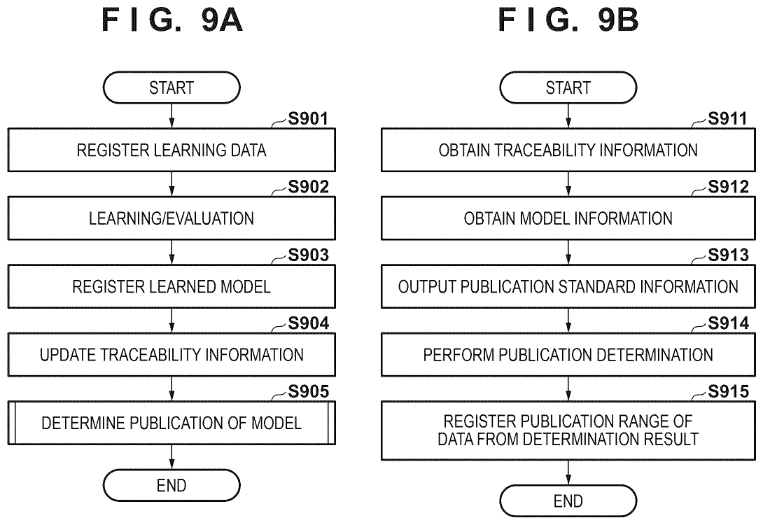

FIGS. 9A and 9B are flowcharts of processing in an information processing apparatus 11 according to the third embodiment. FIG. 9A is a flowchart when learning and registering a model. FIG. 9B is a flowchart when determining/updating the publication range of a model.

First, processing when the user operates the user terminal 14 to register data in the information processing apparatus 11 and learn a model will be described with reference to FIG. 9A. Processes in steps S901 to S904 are the same as those in steps S701 to S704 of the first embodiment (FIG. 7A) and a description thereof will be omitted.

In step S905, the publication determination unit 105 executes model publication determination processing shown in FIG. 9B. That is, publication determination is also performed at the time of registering a model. This can prevent an inappropriate model (a child model substantially identical to a parent model) from being published.

In step S911, the model management unit 101 obtains the traceability information from the traceability information management unit 103.

In step S912, the model management unit 101 obtains the pieces of model information of a model (child model) registered in step S903 and an initial model (parent model) thereof from the obtained traceability information. The obtained model information is transferred to the publication standard information output unit 104.

In step S913, the publication standard information output unit 104 obtains a learning data ID and a learning parameter from the model information of each of the parent model and the child model. Then, the “determination result” of the identity of the learning data between the models and the “learning count of child model” are output as publication standard information.

In step S914, the publication determination unit 105 performs publication determination of the child model based on the publication standard information. The detailed operation of the publication determination in the publication determination unit 105 is as described above.

In step S915, a registration unit 106 updates the value of a publication range in the model information of the child model based on the result of the publication determination in step S914.

Note that in the above description, when newly registering a model, publication determination of the registered model is also performed, but the present invention is not limited to this. For example, a manager terminal 13 can select an arbitrary model at an arbitrary timing, and the publication determination processing shown in FIG. 9B can be executed. At this time, if the publication determination result of the selected model is “private” or “limited publication”, “private” or “limited publication” may also be determined for a derived model of the model based on the traceability information.

As described above, according to the third embodiment, when newly registering a child model in the information processing apparatus, the degree of matching between the child model and its parent model is confirmed and the publication range of the child model is determined based on the degree of matching. In particular, if the degree of matching exceeds a predetermined threshold, “limited publication” or “private” is determined for the child model. Therefore, it is possible to prevent the child model that is substantially identical to the parent model from being published.

### (Modification 3-1)

In the above description, the publication standard information output unit 104 outputs the “determination result” of the identity of the learning data between the models and the “learning count of child model” as publication standard information but may output other information as publication standard information.

For example, for an evaluation image indicated by an evaluation data ID in the model information of the child model, object detection processing is performed using each of the models. Then, Intersection over Union (IoU) between a detection result (BB) by the child model and a detection result (BB) by the parent model is calculated and the IoU value may be output as publication standard information. IoU is an index representing an overlap ratio between two detection results (BBs), and has a value of 0 (inclusive) to 1 (inclusive). As the IoU value is larger, the BBs overlap at a higher ratio. If there are a plurality of evaluation images, the average value of the IoU values for the evaluation images may be output as publication standard information.

In this case, if the IoU value (or the average value) exceeds a predetermined value (for example, 0.99), the publication determination unit 105 evaluates that the similarity between the models is high. That is, if the detection performance for a detection target included in the same image is almost the same between the models, the models can be regarded to be substantially identical.

### (Modification 3-2)

The publication standard information output unit 104 may calculate (for each layer/each kernel) a weight difference in a neural network (NN) between the parent model and the child model, and output the total of the absolute values of the differences as publication standard information.

In this case, if the calculated total is smaller than a predetermined value, the publication determination unit 105 evaluates that the similarity between the models is high. That is, since the weight difference in the NN between the models is small, the models can be regarded to be substantially identical.

### (Modification 3-3)

In model learning in the learning/evaluation unit 107, time-series data of a loss at the time of learning may be stored in the storage unit 12. The loss indicates the difference between a predicted value by the NN and the ground truth of learning data.

Then, the publication standard information output unit 104 calculates publication standard information based on a learning rate of a learning parameter of model information and the time-series data of the loss by:

$$publication standard information = lr \times \sum \vert \partial Loss / \partial w \vert \qquad ( 1 )$$

In equation (1), Ir represents the learning rate, Loss represents a loss at a given time, w represents the weight of the NN of the model, ∂ represents partial differentiation, ∥ represents an absolute value, and Σ represents time accumulation. That is, equation (1) gives a value obtained by multiplying the time accumulation of the absolute value of the gradient of the loss by the learning rate. When this value is large, the weight of the NN largely changes, and when this value is small, the weight slightly changes. That is, the publication standard information corresponds to the degree of learning progress representing how much learning progresses.

If the model registered in step S903 has a parent model based on the traceability information managed by the traceability information management unit 103, the publication determination unit 105 performs publication determination of the model based on the above-described publication standard information. If the calculated publication standard information is smaller than a predetermined value, it can be determined that the weight of the NN of the model in the child model hardly changes from the parent model, and it can be determined that the similarity between the models is high.

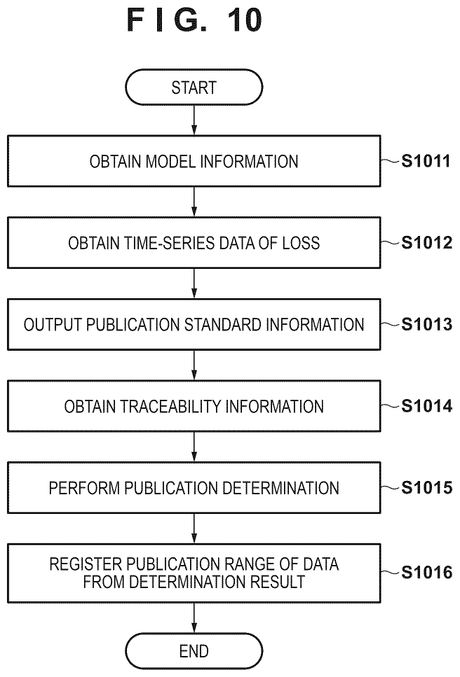

FIG. 10 is a flowchart when determining/updating the publication range of the model according to modification 3-3. Processing of learning and registering a model is the same as in the third embodiment (FIG. 9A) and a description thereof will be omitted.

In step S1011, the model management unit 101 obtains, from the storage unit 12, the model information of a model newly registered via the user terminal 14. The model information is transferred to the publication standard information output unit 104.

In step S1012, the learning/evaluation unit 107 obtains, from the storage unit 12, time-series data of a loss at the time of learning in the model registered in step S903. The time-series data of the loss is transferred to the publication standard information output unit 104.

In step S1013, the publication standard information output unit 104 calculates publication standard information using equation (1).

In step S1014, the publication determination unit 105 obtains the traceability information managed by the traceability information management unit 103.

In step S1015, the publication determination unit 105 confirms whether the model registered in step S903 has a parent model. If the model has a parent model, publication determination of the model registered in step S903 is performed based on the publication standard information calculated in step S1013.

In step S1016, the registration unit 106 updates the value of the publication range in the model information of the model registered in step S903 based on the result of the publication determination in step S1015.

### Fourth Embodiment

In the fourth embodiment, another information processing apparatus that controls the publication range of a learning model will be exemplified below. In particular, a graphical user interface (GUI) that manages traceability information to be provided by a display control unit 108 to a manager terminal 13 and a user terminal 14 will be described. Note that it is assumed that each of the manager terminal 13 and the user terminal 14 is formed by a PC, but the present invention is not limited to this. In addition, colors and line types on the GUI are merely examples, and the present invention is not limited to them.

### <Traceability Information Management Screen>

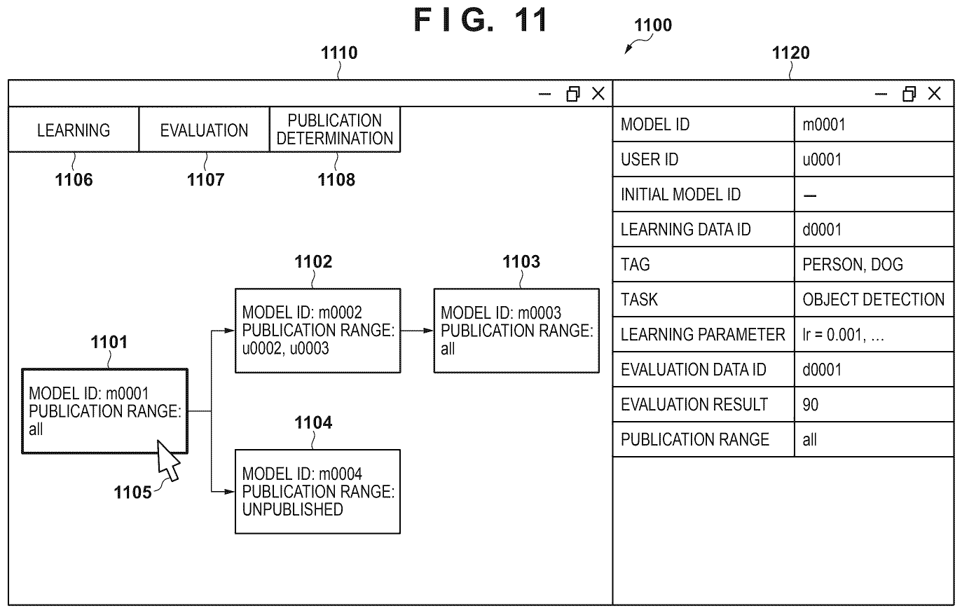

FIG. 11 is a view showing an example of a traceability information management screen 1100. As described above, the management screen 1100 is provided by the display control unit 108 to the manager terminal 13 and/or the user terminal 14. The management screen 1100 includes a traceability information screen 1110 and a detailed information screen 1120. For example, detailed information of a GUI part selected by the user on the traceability information screen 1110 is displayed on the detailed information screen 1120.

On the traceability information screen 1110, models 1101 to 1104 each represented by a rectangle are shown, and the derivative relationship between the models is represented by an arrow in accordance with traceability information (FIG. 5). In addition, a cursor 1105 that instructs a position to the management screen 1100 is shown. The cursor 1105 can move when the user operates, for example, a mouse (not shown). Furthermore, buttons 1106 to 1108 for instructing to execute various kinds of processes are arranged on the traceability information screen 1110.

For each of the models 1101 to 1104, a model ID and a publication range are displayed. The publication range is displayed in text in the rectangle representing each model in this example, but may be displayed by the color of the rectangle. For example, the model whose publication range is “public (all)” may be displayed by a blue rectangle, the model whose publication range is “limited publication (to a specific user)” may be displayed by a light blue rectangle, and the model 1104 whose publication range is “private” may be displayed by a gray rectangle or the like.

The arrow connecting the models indicates the derivative relationship between the learning models. The model connected to the base of the arrow is an initial model, and the model connected to the tip of the arrow is a derived model generated based on the initial model. That is, referring to FIG. 11, the model 1102 is a derived model of the model 1101, the model 1103 is a derived model of the model 1102, and the model 1104 is a derived model of the model 1101. There is no initial model corresponding to the model 1101, and it is indicated that the model 1101 is an unlearned model (for example, a model for which the weight of the NN is set to a random value).

FIG. 11 shows a state in which the model 1101 is selected by the cursor 1105. To explicitly indicate a selected state, the rectangle of the model 1101 is displayed with a thick frame. Furthermore, in FIG. 11, the contents of the model information of the model 1101 are displayed on the detailed information screen 1120.

If the user presses (performs a click operation) a mouse button on the learning button 1106 in the state in which the model is selected, the screen transitions to a learning management screen (not shown), and learning processing can be started using the selected model 1101 as the initial model. If the user performs a click operation for the evaluation button 1107 in the state in which the model is selected, the screen transitions to an evaluation management screen (not shown), and evaluation processing can be executed for the selected model 1101 using evaluation data described in an evaluation data ID. In addition, if the user performs a click operation for the publication determination button 1108 in the state in which the model is selected, the screen transitions to a publication determination management screen (not shown), and publication determination processing of the selected model 1101 and a derived model thereof can be executed.

As described above, according to the fourth embodiment, it is possible to provide (to the manager terminal 13 and/or the user terminal 14) a GUI with which the user can readily grasp the publication state of each model and the derivative relationship between the models. Furthermore, the user can intuitively confirm the detailed information of each model and execute various kinds of processes (learning, evaluation, and publication determination) for each model via the GUI.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-038768, filed Mar. 13, 2024, which is hereby incorporated by reference herein in its entirety.

What is claimed is:

1. An information processing apparatus for managing a plurality of learning models published on a model public platform, comprising:
a management unit that manages, for each of the plurality of learning models, first information concerning a learning history of the learning model, and second information concerning a base model used to create the learning model; and
a determination unit that determines a publication range of each of the plurality of learning models on the model public platform based on both the first information and the second information.

2. The apparatus according to claim 1, wherein
the first information includes information concerning a data set used to learn the learning model, and
the determination unit determines, based on the first information, publication standard information representing whether specific data is used to learn each of the plurality of learning models, and determines a publication range of each of the plurality of learning models based on the publication standard information and the second information corresponding to each of the plurality of learning models.

3. The apparatus according to claim 2, further comprising:
a reception unit that receives designation of the specific data from a manager of the model public platform.

4. The apparatus according to claim 2, wherein
the specific data is data ethically and/or legally restricted in used, and
the determination unit determines, as the publication standard information, one of “limited publication” that narrows the publication range and “private” that prohibits publication in a case where the specific data is used, and determines, as the publication standard information, “public” that does not limit the publication range in a case where the specific data is not used.

5. The apparatus according to claim 4, wherein
in a case where one of the “limited publication” and the “private” is determined for the base model used to create the learning model and identified by the second information, the determination unit determines one of the “limited publication” and the “private” for the learning model.

6. The apparatus according to claim 2, further comprising:
a verification unit that verifies whether a learning model of interest has model performance designated by a manager of the model public platform,
wherein the determination unit determines, for the learning model of interest having the model performance, one of “limited publication” that narrows the publication range and “private” that prohibits publication.

7. The apparatus according to claim 1, wherein
the determination unit determines, based on the first information, publication standard information representing a difference between a learning history of a learning model of interest and a learning history of a base model used to create the learning model of interest and identified by the second information, and determines the publication range of each of the plurality of learning models based on the publication standard information and the second information corresponding to each of the plurality of learning models.

8. The apparatus according to claim 7, wherein
the first information includes a data set and a learning parameter used to learn the learning model, and a learning count, and
in a case where a difference between the data set and the learning parameter used to learn the learning model of interest and the data set and the learning parameter used to learn the base model is smaller than a predetermined percentage and the learning count of the learning model of interest is smaller than a predetermined number, the determination unit determines, for the learning model of interest, one of “limited publication” that narrows the publication range and “private” that prohibits publication.

9. The apparatus according to claim 8, wherein
in a case where one of the “limited publication” and the “private” is determined for the base model used to create the learning model, the determination unit determines one of the “limited publication” and the “private” for the learning model.

10. The apparatus according to claim 1, wherein
the first information includes a result of detection by the learning model with respect to a predetermined data set, and
the determination unit determines, as publication standard information of a learning model of interest, Intersection over Union (IoU) between a result of detection by the learning model of interest and a result of detection by a base model used to create the learning model of interest and identified by the second information, and determines a publication range of each of the plurality of learning models based on the publication standard information and the second information corresponding to each of the plurality of learning models.

11. The apparatus according to claim 1, wherein
the first information includes a weight of a neural network (NN) forming each learning model, and
the determination unit determines, as publication standard information of a learning model of interest, a total of absolute values of differences between the weight of the NN forming the learning model of interest and the weight of the NN forming the base model used to create the learning model of interest and identified by the second information, and determines a publication range of each of the plurality of learning models based on the publication standard information and the second information corresponding to each of the plurality of learning models.

12. The apparatus according to claim 1, wherein
the first information includes a learning rate of a learning parameter and time-series data of a loss at the time of learning each learning model, and
the determination unit determines, as publication standard information of a learning model of interest, a degree of learning progress calculated based on the learning rate and the time-series data of the learning model of interest, and determines a publication range of each of the plurality of learning models based on the publication standard information and the second information corresponding to each of the plurality of learning models.

13. An information processing apparatus for managing a plurality of learning models published on a model public platform,
the plurality of learning models being object detection models each for performing object detection from an image,
the information processing apparatus comprising:
a registration unit that registers a keyword designated by a manager of the model public platform and a ground truth image for the keyword in association with each other;
a management unit that manages, for each of the plurality of learning models, first information concerning a similarity between the ground truth image and a generated image generated by inputting the keyword to the learning model, and second information concerning a base model used to create the learning model; and
a determination unit that determines a publication range of each of the plurality of learning models on the model public platform based on both the first information and the second information.

14. The apparatus according to claim 1, further comprising:
a screen generation unit that generates a management screen to be displayed on a manager terminal operated by the manager of the model public platform,
wherein the management screen is configured to display, as a graphical user interface (GUI), a derivative relationship between the plurality of learning models based on the second information, and a publication state of each of the plurality of learning models.

15. A control method for an information processing apparatus that manages a plurality of learning models published on a model public platform, comprising:
obtaining, for each of the plurality of learning models, first information concerning a learning history of the learning model, and second information concerning a base model used to create the learning model; and
determining a publication range of each of the plurality of learning models on the model public platform based on both the first information and the second information.

16. A non-transitory computer-readable recording medium storing a program that, when executed by a computer, causes the computer to perform a control method for an information processing apparatus that manages a plurality of learning models published on a model public platform, comprising:
obtaining, for each of the plurality of learning models, first information concerning a learning history of the learning model, and second information concerning a base model used to create the learning model; and
determining a publication range of each of the plurality of learning models on the model public platform based on both the first information and the second information.
